(19) United States
(12) Patent Application Publication
(10) Pub. No.: US 2012/0210557 A1
(43) Pub. Date: Aug. 23, 2012

(54) BLIND RIVET

(75) Inventors: Steven V. Jones, Lichfield (GB); Daniel R. Smith, Kidderminster (GB)

(73) Assignee: NEWFREY LLC, NEWARK, DE (US)

(21) Appl. No.: 13/391,963

(22) PCT Filed: Aug. 20, 2010
(86) PCT No.: PCT/US10/46111

§ 371 Date: May 4, 2012

Related U.S. Application Data
(60) Provisional application No. 61/236,270, filed on Aug. 24, 2009.

(51) Int. Cl. B21J 15/02; F16B 13/06; F16B 13/08; F16B 19/08

(52) U.S. Cl. 29/525.06; 411/500; 411/34

(57) ABSTRACT

A blind rivet 200 comprises a mandrel 214 having a deformable mandrel head 218 such that when the blind rivet is received in a pair of aligned apertures of dissimilar sizes in a pair of components 220, 222 to be joined, the mandrel head is adapted to be deformed and cause deformation of a rivet body 202 such that the blind rivet engages the inner surfaces defined by both of the apertures before the mandrel and its head are pulled free of the rivet body.

### CROSS-REFERENCE TO RELATED APPLICATIONS

This application claims the benefit of U.S. Provisional Application No. 61/236,270, filed on Aug. 24, 2009, which is incorporated by reference herein.

### BACKGROUND AND SUMMARY

The present invention relates to blind rivets, and relates particularly to a blind rivet having a mandrel with a deformable mandrel head.

Manufacturing processes such as automotive manufacturing processes use blind rivets as a means of joining parts together since this is a cost effective method avoiding costly and labour intensive tasks which arise when nut and bolt or screw fastenings are used. Blind rivets, which are well known in the art, are used to attach two pieces of material together by means of access to one side of the material. FIGS. 1a-d illustrate a blind rivet 100, known as a break stem rivet, used to join together two pieces of material 102. The blind rivet 100 has a cylindrical rivet body portion 104 with a flange 106 at one end. A mandrel 107, which has an elongated mandrel stem 108 and a head portion 110 at one end, is fed through the rivet body portion 104 such that the head portion 110 of the mandrel 107 engages the opposite end of the rivet body portion 104 to that from which the flange 106 extends.

With reference to FIG. 1a the blind rivet 100 is fed through two overlapping apertures in the pieces of material 102 to be joined together such that the flange 106 engages one of the pieces of material 102. A force F1 is applied to the mandrel stem 108 in a direction away from the pieces of material 102, and a force F2 is also applied to the flange portion 106 in an opposite direction to that of force F1. With reference to FIGS. 1b and 1c, the force F1 applied to the mandrel stem 108 causes the mandrel head 110 to exert a force on the rivet body portion 104 of the blind rivet 100. Such a force causes deformation of the rivet body portion 104 as the mandrel head 110 is pulled towards the pieces of material 102 being joined together, resulting in the creation of an additional flange portion 114.

The mandrel head 110 is pulled through the rivet body portion 104 of the blind rivet 100 until the additional flange portion 114 engages the material 102. Typically the mandrel head 110 is made of harder material than the mandrel stem 108 such that the mandrel stem 108 breaks away from the mandrel head 110 on further application of the force F1 after the additional flange portion 114 engages the material 102. Following this process the two pieces of material 102 are therefore joined together and held in place by the flange 106 and additional flange portion 114.

Pull through blind rivets are also known in the art. Pull through rivets differ from break stem rivets described also in that the mandrel stem does not break away from the mandrel head, and the mandrel head is pulled entirely through the rivet body portion of the blind rivet, and is disposed of with the mandrel stem. U.S. Pat. No. 4,497,603 discloses such a pull through blind rivet.

A problem with conventional break stem and pull through blind rivets, however, is that it is difficult to reliably join pieces of material having dissimilar sized apertures extending therethrough. With further reference to FIG. 1d, for example, if one of the pieces of material 102 had a slightly wider aperture than the other, the rivet body portion 104 of the blind rivet 100 would not engage the entirety of the inner surface defined by the wider aperture. This may then allow the piece of material having the slightly wider aperture to move in a transverse direction. Conventionally this problem would be rectified by drilling a wider aperture in the piece of material 102 having the smaller aperture such that the apertures in the two pieces of material 102 to be joined are of substantially the same size. This complicates and increases the cost of a manufacturing process. Preferred embodiments of the present invention seek to overcome one or more of the above disadvantages of the prior art.

According to the present invention there is provided a blind rivet comprising:

a rivet body having a flange for abutting a work piece and an elongated portion extending from said flange, wherein said elongated portion has a bore for receiving a mandrel head of a mandrel; and

a mandrel having a mandrel head adapted to be located in said bore, and a mandrel stem extending from said mandrel head;

wherein the rivet is adapted to be received in an aperture in a work piece in a first direction such that said flange engages said work piece, and said mandrel head is adapted to be deformed and to cause deformation of said elongated portion as a result of pulling said mandrel head out of said rivet body in a second direction opposite to said first direction.

The use of a deformable mandrel head provides the advantage that a blind rivet can be used to fixably attach pieces of material together having dissimilar sized apertures extending therethrough. In another preferred embodiment said mandrel head has a tapering cross section. In a preferred embodiment said mandrel head has a substantially part-conical cross-section. This allows the mandrel head to slightly enter the rivet body portion prior to its deformation providing the advantage that the rivet body portion is evenly deformed around the aperture extending through it.

In a further preferred embodiment said elongated portion has a plurality of first ribs arranged on an outer surface thereof for engaging an aperture in a work piece. This increases the grip of the rivet on the work piece thereby providing the advantage of minimizing rotation of the work piece relative to the rivet and vice versa. In a preferred embodiment a plurality of said first ribs extends substantially parallel to a longitudinal axis of said elongated portion.

In another preferred embodiment said flange has a plurality of second ribs arranged thereon for engaging an edge of an aperture in a work piece. This increases the grip of the rivet on the work piece thereby providing the advantage of minimizing rotation of the work piece relative to the rivet and vice versa. In a further preferred embodiment a plurality of said second ribs extend transversely to a longitudinal axis of said elongated portion. In a preferred embodiment said bore extends the entire length of said elongated portion.

### BRIEF DESCRIPTION OF THE DRAWINGS

Preferred embodiments of the invention will now be described, by way of example only and not in any limitative sense, with reference to the accompanying drawings in which:

FIG. 1 illustrates a plurality of cross-sectional views of a break stem blind rivet of the prior art in use;

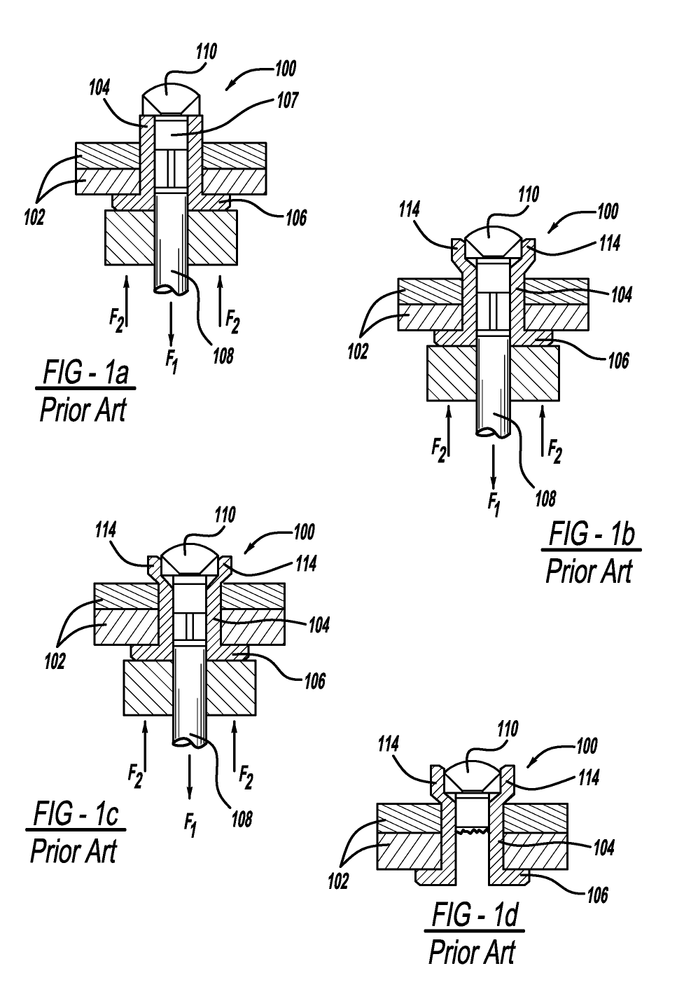

FIG. 2 illustrates a perspective view of a blind rivet of the present invention;

FIG. 3 illustrates a plurality of cross sectional views of the blind rivet in FIG. 2 in use; and

FIG. 4 illustrates a plurality of perspective views of different rivet body portions which may be used in the present invention.

### DETAILED DESCRIPTION

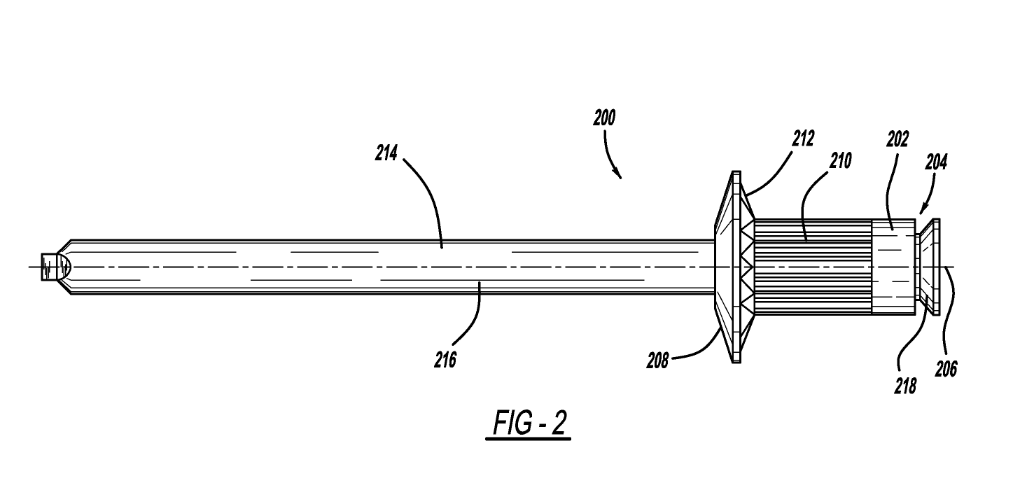

FIG. 2 illustrates a pull through blind rivet 200 embodying the present invention. The blind rivet 200 has a cylindrical rivet body portion 202 having a bore 204 extending entirely through it along an axis 206. The rivet body portion 202 has a flange portion 208 extending from it at one end, and has a partially ribbed outer surface 210. The flange portion 208 also has a ribbed surface 212 on the side of the flange facing the direction of the rivet body portion 202. A mandrel 214 having an elongated mandrel stem 216 and a deformable mandrel head 218 extends through the bore 204 in the rivet body portion 202. The mandrel head 218 is wider than the bore 204 extending through the rivet body portion 202. The mandrel is secured to the rivet body prior to setting by an interference fit between the stem and the bore of the rivet body.

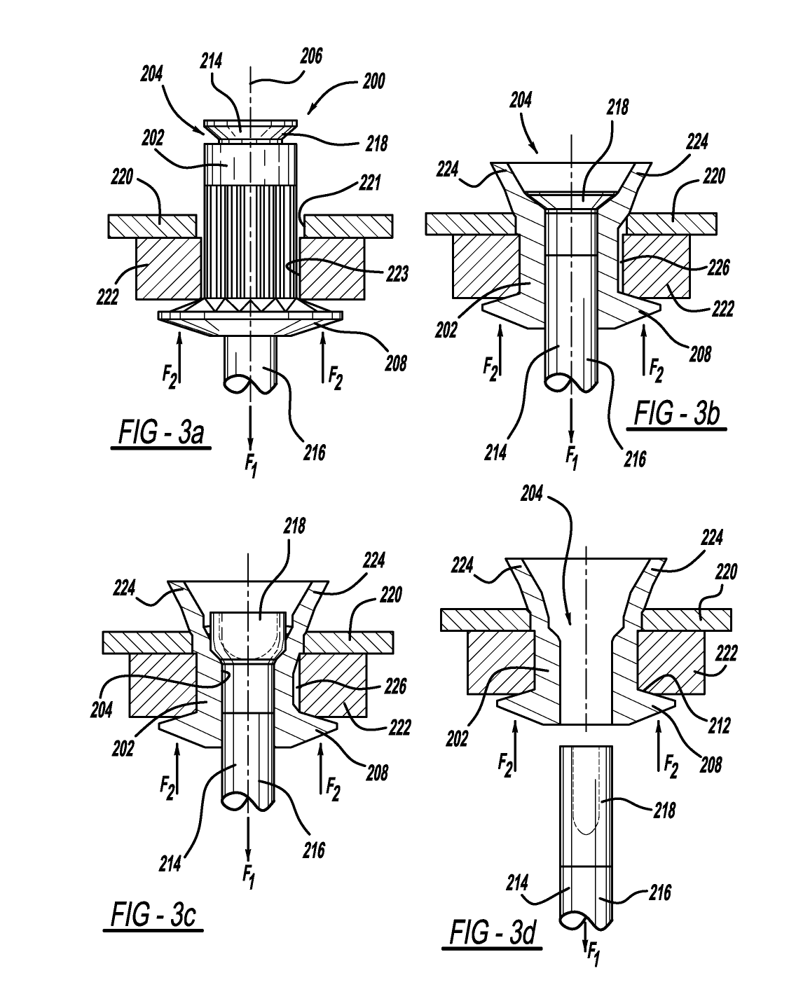

The operation of the blind rivet 200 in FIG. 2, will now be described with reference to FIG. 3. As shown in FIG. 3a, the pieces of material 220, 222 having large and small apertures 221, 223, respectively extending therethrough, are placed in engagement with one another such that the apertures extending therethrough are aligned. The blind rivet 200 is then fed through the aligned apertures in the pieces of material 220, 222 such that the flange portion 208 abuts the surface of the material 222 having the smaller of the two apertures. A force F1 is then applied to the mandrel stem 216 in a direction away from the rivet body portion 202 along axis 206, and a force F2 is applied to the flange portion 208 in the direction of the rivet body portion 202 in a direction opposite to that of force F1. The force F1 pulls the mandrel stem 216 away from the rivet body portion 202 and causes the mandrel head 218 to be pulled into the bore 204 extending through the rivet body portion 202. The tapered surface on the side of the mandrel head 218 adjacent the mandrel stem 216 is brought into engagement with the rivet body portion 202 as the mandrel 214 is pulled away from the rivet body portion 202.

Referring to FIG. 3b, as the mandrel 214 is pulled away from the rivet body portion 202, the mandrel head 218 exerts a force on the mandrel body portion 202 which thereby causes it to deform, resulting in the creation of an additional flange portion 224. As the mandrel head 218 is pulled further through the bore 204 in the rivet body portion 202, the situation illustrated in FIG. 3b occurs, where the additional flange portion 224 comes into engagement with the surface of material piece 220. At this point, the pieces of material 220, 222 are joined and held together by flange portion 208 and the additional flange portion 224 of the tail or blind end of the rivet body. However there exists a gap 226 between the rivet body portion 202 and the inner surface of the apertures extending through both of the pieces of material 220, 222.

In order for the mandrel head 218 to be pulled further through the bore 204 in the rivet body portion 202, the mandrel head 218 must deform so as to fit through the larger aperture in material piece 220, which is narrower than the width of the mandrel head in its initial state. FIG. 3c illustrates the mandrel head 218 having deformed a sufficient amount to fit through the larger aperture in material piece 220. As the mandrel head 218 is pulled through this aperture, the mandrel body portion 202 deforms further such that it is brought into engagement with the inner surface defined by the aperture in material piece 220. At this point however, there still exists a gap 226 between the rivet body portion 202 and the inner surface of the smaller aperture extending through material piece 222.

As the mandrel head 218 is pulled further through the bore 204 in the rivet body portion 202, the mandrel head 218 deforms further such that it can fit through the smaller aperture in material piece 222, which is narrower than the width of the mandrel head 218 after being pulled through the larger aperture in material piece 220. The mandrel head 218 is therefore deformed a sufficient amount such that it may be pulled through the smaller aperture in material piece 222, and as it is pulled through this aperture, the mandrel body portion 202 is again further deformed such that it is brought into engagement with the inner surface defined by the smaller aperture in material piece 222. The mandrel stem 216 and mandrel head 218 are then pulled such that they are completely separated from the rivet body portion 202 as illustrated in FIG. 3d.

Following this process, the two pieces of material 220, 222 are joined together in such a way that they can not move relative to each other. The ribs 210 (see FIG. 2) on the outer surface of the rivet body portion 202 engage the inner surfaces of the apertures in both material pieces 220, 222 so as to increase the grip of the rivet body portion 202 on the pieces of material 220, 222 and thereby prevent rotation of the joined pieces of material 220, 222 about the rivet body portion 202. As the mandrel head 218 is pulled out of the bore 204 in the rivet body portion 204, the outer surface of the rivet body portion 202, and therefore the flange 208 extending from it, deform in such a way that the ribbed surface 212 (see FIG. 2) of the flange 208 is forced against the material piece 222 thereby preventing rotation of the rivet body portion 202 relative to the material piece 222. The rivet body is thereby permanently fastened to the workpieces during normal use.

If the pieces of material being joined by a blind rivet 200 of the present invention are electrical conductors, the blind rivet 200 is able to form a joint between the two pieces of material which has earth or grounding continuity. For example, workpiece 220 is a conductive metal eyelet attached to an electrical wire and workpiece 222 is a stamped steel panel of an automotive vehicle or electronic cabinet, such as a computer or server chassis. The panel workpiece 222 acts as a grounded electrical conductor if electricity flows to it from conductive eyelet 220. Alternately, workpiece 222 may be the eyelet and workpiece 220 may be the grounding panel whereby ribs 212 of flange 208 dig into and deter eyelet 222 from rotation. In these examples, it is desirable to deter rotation of the conductive eyelet relative to the adjacent panel by way of the blind rivet ribs 210 and 212.

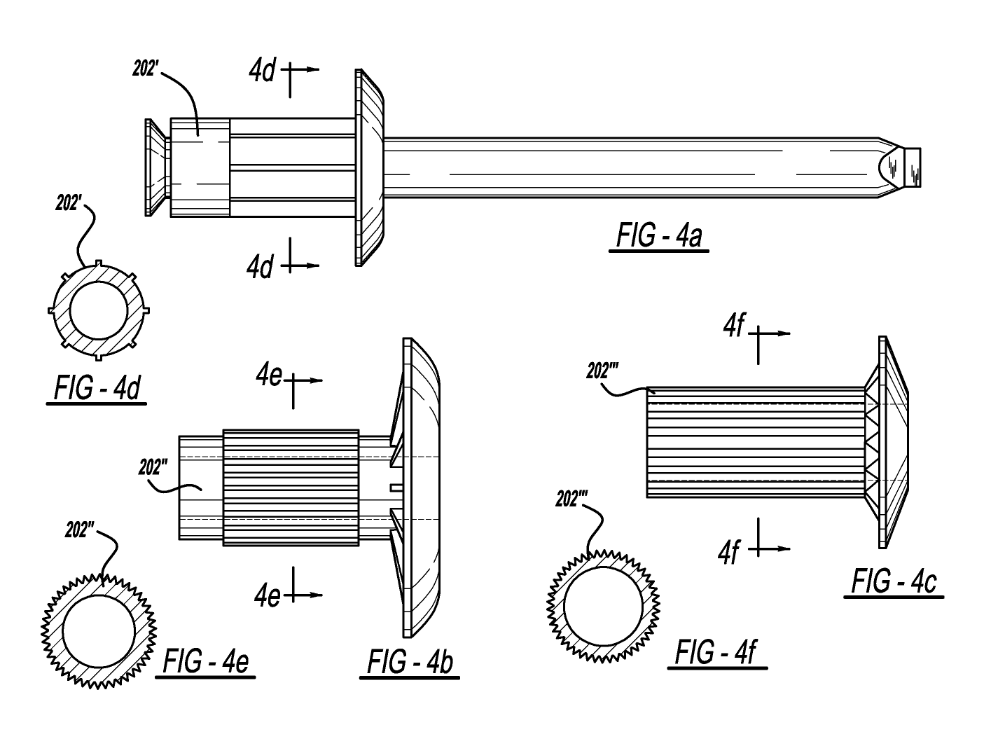

FIG. 4 illustrates various other rivet body portion 202 outer surface configurations. In particular, FIGS. 4a and 4d illustrate a rivet body portion 202′ having a partially splined outer surface, and FIGS. 4b, 4c, 4e and 4f, illustrate a rivet body portion having a partially (202″) and entirely (202′″) ribbed outer surface, respectively. In the embodiment of FIGS. 4b and 4e, the outer surface of the rivet body section is free of discontinuities (i.e., circular-cylindrically smooth) between the axially elongated ribs on the body section and the laterally elongated ribs on the underside of the flange.

It will be appreciated by persons skilled in the art that the above embodiments have been described by way of example only and not in any limitative sense, and that various alterations and modifications are possible without departure from the scope of the invention as defined by the appended claims. For example the blind rivet of the present invention may be used to join more than two pieces of material together.

The invention claimed is:

1. A blind rivet assembly comprising:
a rivet body including a middle section having a substantially cylindrical through-bore at least prior to blind rivet setting, a flange laterally extending from a tool-end of the middle section, and a set of ribs extending from an underside of the flange; and
a mandrel including an axially elongated stem and a laterally enlarged head extending adjacent a blind end of the stem, the stem extending through the bore of the rivet body prior to blind rivet setting and the head deforming during blind rivet setting as it is pulled completely through the rivet body.

2. The blind rivet assembly of claim 1, further comprising at least two workpieces fastened together by the rivet, internal apertures of the workpieces having intentionally different lateral dimensions, the middle section of rivet body being laterally expanded to fill the internal apertures when the mandrel head is pulled through the rivet body.

3. The blind rivet assembly of claim 2, wherein at least one of the workpieces conducts electricity.

4. The blind rivet assembly of claim 2, wherein one of the workpieces is an electrical eyelet and is deterred from rotation by engagement thereof by the ribs.

5. The blind rivet assembly of claim 1, further comprising a set of axially elongated ribs projecting from an outer surface of the rivet body at least prior to rivet setting.

6. The blind rivet assembly of claim 5, wherein the outer surface of the rivet body is circular-cylindrically smooth and free of discontinuities between the axially elongated ribs and the ribs on the flange.

7. The blind rivet assembly of claim 5, wherein the axially elongated ribs are parallel to the elongated mandrel axis prior to rivet setting.

8. The blind rivet assembly of claim 1, wherein the flange and a laterally expanded tail section of the rivet body axially extend beyond outside surfaces of the fastened workpieces after rivet setting.

9. The blind rivet assembly of claim 1, wherein the middle section of the rivet body has an axial step in an outer surface thereof between a laterally expanded blind tail section and the flange, after rivet setting.

10. The blind rivet assembly of claim 1, wherein each of the ribs is angled so as to axially project a greater distance from the flange closer to the middle section, and the ribs of the flange also contact against the middle section of the rivet body.

11. The blind rivet assembly of claim 1, wherein the blind end of the rivet body outwardly and rearwardly projects away from the flange and the middle section, after rivet setting.

12. The blind rivet assembly of claim 1, wherein the mandrel is secured to the rivet body by an interference fit prior to rivet setting, and the stem of the mandrel is substantially smooth and free of discontinuities between the rivet body and a tapered tool-end of the stem at least prior to rivet setting.

13. A blind rivet assembly comprising:
a rivet body including a middle section having a substantially cylindrical through-bore at least prior to blind rivet setting and a flange laterally extending from an end of the middle section;
a mandrel including an axially elongated stem and a laterally enlarged head extending adjacent a blind end of the stem, the stem extending through the bore of the rivet body prior to blind rivet setting;
workpieces fastened together by the rivet, internal apertures of the workpieces having intentionally different lateral dimensions, an outer surface of the middle section of the rivet body being laterally expanded in an axially stepped manner to completely fill the internal apertures when the mandrel head is deformed and completely pulled through the rivet body during blind rivet setting.

14. The blind rivet assembly of claim 13, further comprising a set of ribs extending from an underside of the flange of the rivet body, the ribs of the flange engaging the adjacent one of the workpieces to deter rotational movement therebetween.

15. The blind rivet assembly of claim 14, wherein each of the ribs of the flange is angled so as to axially project a greater distance from the flange closer to the middle section.

16. The blind rivet assembly of claim 13, wherein one of the workpieces is an electrical eyelet.

17. The blind rivet assembly of claim 13, further comprising axially elongated ribs, located on the outer surface of the middle section, being parallel to the axially elongated stem prior to rivet setting, wherein at least one of the workpieces is an electrical conductor and is deterred from rotation by engagement thereof by the ribs.

18. The blind rivet assembly of claim 13, wherein the flange and a laterally expanded tail section of the rivet body axially extend beyond outside surfaces of the fastened workpieces after rivet setting.

19. The blind rivet assembly of claim 13, further comprising axially elongated ribs being parallel to the elongated mandrel axis prior to rivet setting and each of the ribs having a triangular cross-sectional shape prior to rivet setting.

20. The blind rivet assembly of claim 13, wherein the blind end of the rivet body outwardly and rearwardly projects away from the flange and the middle section after rivet setting, and the mandrel is secured to the rivet body by an interference fit prior to rivet setting.

21. The blind rivet assembly of claim 13, wherein at least one of the workpieces is a grounded automotive vehicle panel.

22. The blind rivet assembly of claim 13, wherein at least one of the workpieces is part of a grounded electronics cabinet.

23. A blind rivet assembly comprising:
a blind rivet body including an axially elongated middle section having a substantially cylindrical through-bore at least prior to rivet setting and a flange laterally extending from a tool-end of the middle section;
a mandrel including an axially elongated stem and a laterally enlarged head extending adjacent a blind-end of the stem, the stem extending through and being secured to the bore of the blind rivet body in an interference fit prior to rivet setting;
workpieces fastened together by the blind rivet body, at least one of the workpieces acting as a ground and conducting electricity, internal apertures of the workpieces having different lateral dimensions, an outer surface of the middle section of the blind rivet body being laterally expanded in an axially stepped manner to completely fill the internal apertures when the mandrel head is deformed and completely pulled through the blind rivet body during rivet setting;
a first set of ribs extending from an underside of the flange of the blind rivet body, the ribs of the flange engaging the adjacent one of the workpieces to deter rotational movement therebetween;
a second set of axially elongated ribs radially projecting from the blind rivet body being parallel to an elongated mandrel axis prior to rivet setting, the second set of ribs engaging the apertures of the workpieces to deter rotation of the workpieces relative to each other; and
a laterally expanded blind end of the blind rivet body axially extending beyond the adjacent outside surface of fastened workpieces after rivet setting, and the blind end of the blind rivet body outwardly and rearwardly projecting away from the flange and the middle section, after rivet setting.

24. A method of fastening a blind rivet to workpieces, the method comprising:
(a) inserting a pre-assembled blind rivet body and mandrel into holes of workpieces, the holes having different inside diameters;
(b) pushing projections extending from a flange of the rivet body into engagement with the adjacent one of the workpieces during rivet setting;
(c) pulling a head of the mandrel completely through the rivet body during rivet setting;
(d) increasing the outer diameter of a section of the rivet body during step (c) to push axially elongated formations on an outer surface of the rivet body to engage the inside diameters of the workpieces;
(e) deterring rotation of the workpieces by engagement of the projections and formations therewith;
(f) filling the holes of the workpieces with the adjacent section of the rivet body during rivet setting to prevent gaps between the rivet body and the workpieces; and
(g) permanently attaching the rivet to the workpieces.

25. The method of claim 24, further comprising supplying electricity from one of the workpieces to the other at least in part, through the rivet.

26. The method of claim 24, further comprising expanding a blind end of the rivet body so it extends axially away from the flange and outwardly away from an axial centerline of the set rivet body.

27. The method of claim 24, further comprising deforming the mandrel head during rivet setting and causing an exterior bore of the rivet body to be unobstructed after rivet setting, wherein the workpieces have different thicknesses with the thinner workpiece having the larger inside diameter hole.
